(19) United States
(12) Patent Application Publication
(10) Pub. No.: US 2023/0100391 A1
(43) Pub. Date: Mar. 30, 2023

(54) SYSTEM AND METHOD FOR DIFFERENTIAL ENRICHMENT OF WATER

(71) Applicant: STRAUSS WATER LTD, Or Yehuda (IL)

(72) Inventors: Eddy MAKMEL, Mazkeret Batya (IL); Orit AMSALEM-BERGELSON, Rehovot (IL); Liron ALMISHALI, Petach Tikva (IL); Haya SANDORI KAZAZ, Gedera (IL)

(21) Appl. No.: 17/799,131

(22) PCT Filed: May 20, 2021
(86) PCT No.: PCT/IL2021/050588

§ 371 Date: Aug. 11, 2022

Related U.S. Application Data
(60) Provisional application No. 63/028,274, filed on May 21, 2020.
(60) Provisional application No. 63/134,856, filed on Jan. 7, 2021.

(51) Int. Cl. C02F 1/00; C02F 1/68

(52) U.S. Cl. CPC C02F 1/008; C02F 1/68; C02F 2209/001; C02F 2209/05; C02F 2209/09; C02F 2209/10; C02F 2209/06; C02F 2209/11; C02F 2209/02; C02F 2307/10

(57) ABSTRACT

The present disclosure concerns systems and methods for enrichment of water, more specifically controlled addition of minerals and other nutrients into untreated water or water which have been preliminary treated to selectively remove contaminants therefrom in order to obtain a desired nutrients' profile in the water for use consumption.

### TECHNOLOGICAL FIELD

The present disclosure concerns systems and methods for enrichment of water, more specifically controlled addition of minerals and other nutrients into untreated water or water which have been preliminary treated to selectively remove contaminants therefrom.

### BACKGROUND

Drinking water from different sources (i.e. natural sources, wells, desalination facilities, recycling facilities, etc.) and different geographical locations vary in their quality and minerals content. Often, drinking water undergo various treatment processes before consuming, such as reverse osmosis, filtering, desalination, distillation, etc. Such treatments often significantly reduce the minerals content in the water. As water are an important source of essential minerals (such as magnesium and calcium), such treatments often result in consumption of minerals-poor water which can lead to mineral deficiencies in the body of the consumer over prolonged periods of time.

Systems and compositions for mineral enrichment of water are known. Typically, such systems are based on adding a uniform (or constant) amount of soluble additives into water before consumption, regardless of the actual original minerals content in the water. Further, many of such systems are found in water dispensers in which water undergo reverse osmosis processes, which removes most, if not all, of the minerals from the water; this in fact results in minerals-free water, to which addition of a constant, pre-defined known amount of minerals can be carried out, thereby obtaining a desired amount of minerals in the water, regardless of the original mineral content in the source water.

In the case of untreated water, or water undergoing various filtration processes, the removal of minerals is in minute quantities which are difficult to control accurately, hence the content of minerals in each dispensed dose of water can vary, for example based on the source of water, filtration type, presence of contaminants from the domestic waterline, etc. Addition of a constant amount of minerals into such water often results in under-mineralization or over-mineralization, without the ability to control the actual total amount of minerals to be consumed in each dose of dispensed water.

Hence, there is a need for systems and methods that will permit controlled addition of minerals and other nutrients to water depending on the actual minerals and/or nutrients content in the water in a manner permitting to obtain a controlled and desired amount of minerals and/or nutrients to be consumed by the user.

### General Description

The systems and methods disclosed herein enable specific addition of at least one nutrient to drinking water, based on the actual amount of said nutrient present in the water before such addition. In other words, systems and methods of this disclosure provide means for differentially adding nutrients into water, depending on the amount of said nutrient already present in the water before such addition in order to reach a desired level of said nutrient in the water that is considered optimal for user consumption.

The systems and methods of this disclosure are based on the understanding that the amount of nutrients in water can be measured or assessed before consumption, and by comparison to a desired value of said nutrient, nutrients can be added to the water in just the proper amount in order to reach the desired amount of nutrient.

Unlike other systems and methods in which a constant amount of nutrients is added regardless of the amount of nutrients already existing in the water, the systems and methods of this disclosure permit highly controlled addition of nutrients in order to allow a user to consume doses of water which are similar or even identical in their nutrients content.

According to a first aspect of this disclosure, there is provided a system for differential addition of at least one nutrient into drinking water, the system comprises a water flow-line extending between a water source and a water dispensing outlet; at least one nutrient dispensing unit upstream the dispensing outlet configured for on-demand addition of at least one nutrient into the water flow-line; at least one sensor disposed in the flow-line, and a processing and controlling utility. The at least one first sensor is configured to provide a first value of at least one measurable parameter of the water that is correlative to the amount of said at least one nutrient in water from the water source. The at least one sensor is positioned upstream the at least one nutrient dispensing unit within the flow-line. The processing and controlling utility is configured to receive said first value from said at least one first sensor, determine the amount of said nutrient in the water based on said first value, and determine an amount of said at least one nutrient to be added to the water from said nutrient dispensing unit for obtaining a pre-determined total amount of said nutrient in the water.

In other words, based on a measurement of the actual content of the at least one nutrient in the water, the system determines how much additional nutrient needs to be added to the water in order to arrive at a pre-determined total amount of nutrient in the water that is optimal for user consumption.

It is important to note that various water sources vary in their nutrients (e.g. minerals) quantities. Hence, drinking water which may be received via the municipal water systems from one or more sources (e.g. river, lake, reservoir, well, desalination plant, water recycling plant, etc.) significantly vary in their quality and uniformity, such that every consumed dose (e.g. a glass of water) can contain a different amount of nutrients. Even if the source of water is bottled water (e.g. several gallons' jugs), the water in each jug can contain a slightly different nutrients profile. Furthermore, water supply lines (for example copper, brass or steel water lines) can also release various minerals into water, the amount of which needs to be determined before consumption. Additionally, the system can be provided with input concerning the quality of the source water (e.g. the system can be configured to receive quality of water in real-time from a service center, which can vary depending on numerous factors, including the type of water source, the geographical location thereof, the season of the year, etc.), thus providing a starting value for the actual nutrient content in the water prior to addition of the nutrient.

The systems and methods of this disclosure are meant to provide a uniform nutrients profile in each consumed dose of water, depending on the measured amounts of nutrients in the source water.

In some embodiments, the processing and controlling utility is configured to (i) calculate a difference between a desired total amount of said at least one nutrient in the water and the actual amount of said nutrient based on said first value, and (ii) operate the nutrient dispensing unit to add an added amount of said nutrient to the water, said added amount being correlative to said difference. This enables differentiated addition of nutrients to each dispensed/consumed water dose, depending on the nutrients content in the source water.

By some embodiments, the at least one parameter sensed (or measured) by the first sensor may be selected from conductivity, total dissolved solids (TDS), pH, turbidity, nutrient content, color, light absorbance, salinity, and any other parameter indicative of the concentration of the nutrient in the water.

By an embodiment, the at least one first sensor is selected from a conductivity sensor, an optical sensor, a spectroscopic sensor, a magnetic sensor, a laser sensor, a viscosity sensor, radiofrequency sensor and any other suitable sensor to assess said parameter.

The value of a desired parameter (e.g. conductivity, turbidity, presence/absence of specific ions, etc.) sensed by the first sensor is transmitted to the processing and controlling unit, and forms a basis for the calculation of actual nutrient concentration in the water.

The system, by an embodiment, comprises at least one second sensor, positioned in the flow-line between said nutrient dispensing unit and said water dispensing outlet, and is configured to provide a second value of said measurable parameter. This second value can be used as a quality control indicator, for verifying that the required amount of nutrient has been added to the water.

The second sensor may be selected, independent from the first sensor, from is selected from a conductivity sensor, an optical sensor, a spectroscopic sensor, a magnetic sensor, a laser sensor, a viscosity sensor, radiofrequency sensor and any other suitable sensor to assess said parameter.

In some embodiments, the first sensor and the second sensor are of the same type. In other embodiments, the type of the first sensor is different from the type of the second sensor.

The system may also comprise, by an embodiment, at least one temperature sensor configured to measure the temperature of the water in said water flow-line. As the first and second values measured by the first and second sensors, respectively, may be affected by the temperature of the water, the processing and controlling unit may be configured to receive the measured temperature and determine the amount of said nutrient in the water based on said first and/or second values as a function of said measured temperature.

The system may comprise at least one additional sensor, which may be selected from a pH sensor, alkalinity sensor, salinity sensor, turbidity sensor, a total dissolved solids (TDS) sensor, a flow sensor, or any other suitable sensor.

The nutrient, by some embodiments, can be selected from minerals, vitamins, amino acids, fatty acids, proteins, flavoring agents, odorants, food supplements, peptides, antioxidants, nutraceuticals, probiotics, emulsifiers, thickening agents, antifoaming, colorants, flavor masking agents (e.g. gum arabic), preservatives, stabilizers, stimulants (such as caffeine, tea extract or concentrate, coffee extract or concentrate, chocolate), alcoholic compounds, juice, juice concentrate, and any combination thereof.

According to some embodiments, the system further comprises one or more water treatment modules, located upstream said first sensor. The water treatment module(s) are designed to carry out preliminary treatment of the source water in order to remove various contaminants, e.g. microbiological contaminants, small particles or fibers, heavy metals, chlorine, organic materials, trihalomethanes (THMs), pesticides, hormones, drugs, etc., which are undesired for user's consumption; however substantially without removing minerals from source water, which are beneficial for user's consumption. This enables not only maintaining the desired nutrients in the water and removing undesired contaminants therefrom, but also enables utilizing a measured amount of the minerals in the water as an indication of the water quality (as will be further detailed below).

In some embodiments, the nutrient is at least one mineral. The mineral is typically an essential mineral, and may be selected from calcium, magnesium, zinc, selenium, phosphorus, potassium, sulfur, sodium, iron, copper, manganese, iodine, molybdenum, chromium, fluoride, inorganic salts thereof (such as chloride, carbonate or bicarbonate salts) and/or organic salts thereof.

In other embodiments, the nutrient is at least one vitamin. The vitamin can be typically selected from vitamin A, vitamin B (e.g. one or more of vitamin B1 (thiamine), B2 (riboflavin), B3 (niacin), B5 (pantothenic acid), B6 (pyridoxine), B7 (biotin), B9 (folate) and B12 (cobalamin)), vitamin C, vitamin D, vitamin E, etc., in a single vitamin formulation or as a vitamin complex or multivitamin formulation. The at least one vitamin may be added to the water in a desired quantity, e.g. at a quantity of about 1-35% of the recommended daily amount.

Unlike known systems which are based on complete removal of all nutrients (including all types of minerals) for water, e.g. by reverse osmosis, and then adding a constant amount of the nutrient (mineral, for example) to the water (or addition of uncontrolled amount of minerals, e.g. by ion exchange or re-mineralization by mineral rock dissolution)—utilizing treated water which maintain the original minerals from the source water, results in optimal utilization of the added nutrient based on the actual amount of nutrients (e.g. minerals) in the water before such addition. More so, by selectively removing the organic materials and heavy metals from water prior to measuring the mineral content in the water, a more precise measurement can be carried out of the actual mineral content of the water, thus permitting precise calculation of the amount of minerals to be added on a water portion-by-portion basis (i.e. a precise measurement can be carried out for each dispensed volume, e.g. a glass of water, before dispensing from the system).

Further, it was found by the inventors of the present invention, that better correlation between minerals content and various measurable parameters of water can be more accurately established once organic materials are removed from the water. Hence, removal of organic materials before obtaining said first value can assists in improving the accuracy of said first value.

The system may further comprise at least one additive dispensing unit, positioned downstream said nutrient dispensing unit, and configured to add a desired amount of at least one additive to the water (the additive being different from the at least one nutrient). In some embodiments, said additive is selected from vitamins, amino acids, fatty acids, proteins, flavoring agents, odorants, food supplements, peptides, antioxidants, nutraceuticals, probiotics, emulsifiers, thickening agents, antifoaming, colorants, flavor masking agents, preservatives, stabilizers, stimulants (such as caffeine, tea extract or concentrate, coffee extract or concentrate, chocolate), alcoholic compounds, juice, juice concentrate, and any combination thereof.

The nutrient dispensing unit, by an embodiment, comprises at least one container for holding a composition comprising said at least one nutrient. The composition may comprise a single type of nutrient or may comprise a blend of one or more types of nutrients. The nutrient may be provided in a diluted form or may be in the form of a concentrate.

The nutrient can be present in the composition in an encapsulated form. Such encapsulation is particularly desired for delivery of hydrophobic nutrients. In addition, such encapsulation may reduce the conductivity of water, as encapsulated minerals typically do not increase the conductivity of water. Thus, such encapsulation enables to maintain the conductivity of the water constant (i.e. the same conductivity before and after mineral addition), in spite of the favorable addition of minerals.

In some embodiments, the nutrient dispensing unit comprises a plurality of containers, each independently holding a different composition. The processing and controlling unit is typically configured to selectively add a required amount of nutrients from said plurality of containers as a function of said first value.

The containers may be re-fillable (i.e. a constant container which can be filled). In other embodiments, the containers may be replaceable and/or dispensable. The containers can be provided separately or as a cartridge that holds several containers.

The nutrient can be provided in various formed, e.g. liquid, gel, solids, powders, solution, emulsion, dispersion, etc.

According to some embodiments, when the nutrient is at least one mineral, the nutrient dispensing unit may comprise a concentrate receptacle that holds one or more mineral-containing solids (e.g. mineral particles, mineral pebbles, mineral rocks, etc.), that can be used to enrich the water in minerals via dissolving of the minerals from the solids into the water over time to form a mineral concentrate. The mineral concentrate is then used as a reservoir for addition of minerals into the water feed line. The concentrate receptable is configured to receive water from the water flow line (via a water inlet) and further configured to controllably dispense the mineral concentrate into the flow-line downstream the first sensor. In other words, when a concentrate receptacle is to be used, the water stream in the water flow-line is split into two flow paths: a main flow path defined between the water source and the water dispensing outlet, and an auxiliary flow path in which water is diverted from the main flow path (i.e. the water flow line) into the concentrate receptacle. Enrichment of water flowing in the auxiliary flow path is then obtained by permitted the water to dissolve one or more minerals from the solids contained in the concentrate receptacle, and the enriched water are then returned into the water flowing in the main flow path (i.e. flowing in the water flow line) in a controlled manner.

In such systems, the nutrient dispensing unit may comprise at least one auxiliary sensor for determining the amount of minerals in the concentrate before dispensing the concentrate into the water flow-line. The processing and controlling utility is configured to receive a mineral concentration value from the auxiliary sensor (indicative of the mineral content in the concentrate, for example a conductivity value or a TDS value), and determine the volume of concentrate that needs to be added into the flow line based on the first value (i.e. content of minerals in the source water) and the mineral concentration value for obtaining a pre-determined total amount of minerals in the water.

By some embodiments, the nutrient dispensing unit further comprises at least one water pre-treatment module, disposed between the water flow line and a water inlet of the concentrate receptacle, capable of removing at least a portion of the minerals in the auxiliary flow path. In other words, the pre-treatment module is located between a water flow path splitting point (the point along the water flow line in which the flow paths of the water are split between the main flow line and the auxiliary flow line) and the concentrate receptacle. Such pre-treatment permits obtaining water with reduced amount of undesired minerals before enrichment with desired minerals within the concentrate receptacle.

The system of this disclosure permits to personalize the profile of consumed water based on user's preference and user's profile. For example, the daily recommended amount of nutrients varies depending on age, weight, gender, medical condition, geographical location, lifestyle, etc. Thus, the system can be programmed to store various users profiles, and provide the exact amount of nutrients needed for each user, for example by dispensing different amounts and/or different combinations of nutrients into the water. Alternatively, the system can receive the user's profile from an external database. In another embodiment, the system can be configured with an array of sensors to identify the gender of a user and assess its age and/or weight.

In some embodiments, the pre-determined total amount of said nutrient is based on a user's profile; the processing and controlling utility is configured to induce addition of nutrient to the water based on said user's profile to arrive at a desired final content of the nutrient specific for each user (or consumer).

In another embodiment, the system can be personalized to add nutrients to the water depending on the organoleptic preference of the consumer. For example, it is known that different content of some nutrients (e.g. minerals such as calcium and magnesium) causes water to be sensed by the tongue differently. Water that is high in mineral content will be often sensed as “rough” (what is known as “tough” water), while water that is low in mineral content will be sensed as “smooth” or “soft” water. According to consumer preference, one or more nutrients can be added to the water, depending on the initial measured value of the nutrient in the water, in order to obtain a desired organoleptic property of the water.

The system can also comprise a user identification module, for identifying the user prior to operation of the system. For example, the identification module can be a finger-print unit, a voice recognition unit, a camera-based utility for identifying facial features, etc., and the system can operate based on the user profile allocated to each identified user. In addition, such an identification module can be used as a safety means for preventing utilization of improper user profile. For example, the identification module can identify whether a child or an adult has operated the system, thereby preventing application of an adult-based profile when a child operates the system.

By further embodiments, the system can further comprise one or more user-interface modules, associated with the processing and controlling utility, for operating the system and/or displaying one or more notifications to the user. For example, the user interface can display the type and/or amount of nutrients added, one or more measured parameter, one or more informatory notifications, one or more nutritional recommendations, etc.

According to some embodiments, the user interface is configured to display at least the TDS value of the water before, during and after addition of the nutrient(s). For example, the TDS value after treating the water by reverse osmosis is typically low to zero (and can attests to the effectiveness of the reverse osmosis treatment). The user interface can thus present the user with the initial measured TDS value before addition of the nutrient, during addition of the nutrient, and the final value after addition has been completed (in which the TDS value should be higher than the initial TDS value) — such that the increase in TDS value to a desired given value can serve as an indicator to the user of the proper and controlled addition of the nutrient to the water.

In another aspect, the present disclosure provides a system for differential addition of at least one nutrient into drinking water, the system comprising: a water flow-line extending between a water source and a water dispensing outlet; at least one nutrient dispensing unit upstream the dispensing outlet configured for on-demand addition of at least one nutrient into the water flow-line; at least one first sensor configured to provide a first value of at least one measurable parameter of the water that is correlative to the amount of said at least one nutrient in water from the water source, the at least one sensor being positioned upstream the at least one nutrient dispensing unit in the flow-line; and a controller configured to transmit said first value to a processing utility, receive from said processing utility a calculated value indicative of the difference between a measured amount of said nutrient based on said first value and a pre-determined total desired amount said nutrient, and operate said nutrient dispensing unit to dispense an added amount of said nutrient to the water based on said calculated value.

By another aspect, there is provided a water dispenser that comprises the system disclosed herein.

The water dispenser may comprise additional systems, such as water-cooling system, water heating system, units for flavor additives, etc. In some embodiments, the dispenser comprises a water carbonation unit for carbonating the water prior to dispensing. The carbonation unit is typically positioned downstream the at least one first sensor, as to prevent carbonation from effecting the values of parameters measured by the first sensor. Carbonation can be carried out at any point in the water flow-line downstream the first sensor, e.g. before nutrient addition, after nutrient addition, prior to dispensing, etc.

However, it is also contemplated within the scope of this disclosure that the systems described can be fitted onto any drinking water feed line, e.g. domestic main line.

A method of enriching drinking water with at least one nutrient is also an aspect of this disclosure. The method comprises:
measuring a first value of at least one measurable parameter of the water provided from a water source by at least one first sensor, said measurable parameter being correlative to the amount of said at least one nutrient in the water,
transmitting said first value to a processing utility, in which a difference (Δ) between an amount of said nutrient based on said first value (P1) and a desired total amount (P2) of said at least one nutrient is determined, and
receiving said difference or a calculated value base thereon to induce addition of an added amount of said nutrient to the water, such that:
   (a) if said difference is negative ((P1−P2=Δ)<0), an added amount of said at least one nutrient is added to the water from at least one nutrient dispensing unit, said added amount being correlative to said difference; and
   (b) if said difference is zero or positive ((P1−P2=Δ)≥0), no added amount of nutrient is added to the water.

The measurement by the first sensor is typically carried out in-line within a water flow-line defined between the water source and a water dispensing outlet.

In some embodiments, said difference, or a value based thereon, is transmitted from the processing utility to a control utility that is configured to operate the at least one nutrient dispensing unit.

By another embodiment, in case said difference is positive and exceeds a pre-defined threshold value, the processing utility transmits an indication to a control center. This can serve as a water quality indication attesting to the water quality received from the source, and/or enabling to detect malfunction in the municipal supply line, a local pipeline or a local reservoir. In such cases, the processing unit may be configured to induce shut-off of the water supply from said water source in case said difference is positive and exceeds a pre-defined threshold value.

In other embodiments, the processing utility may provide a water quality indication by calculating a difference between a measured amount of the nutrient in the water received by the system based on said first value and an amount of the nutrient measured at the water source. Such data can be provided to the processing utility from a dedicated database, a municipal data system, water quality monitoring data from the water supplier, etc.

Further, by measuring the quantity of nutrients in the water, the system and methods of this disclosure can be used to detect and alert on malfunction of water pre-treatment processes. For example, when the systems and methods of this disclosure are applied for addition of nutrients after water has been treated by reverse osmosis (that when functioning properly should remove all nutrients from the water), indication that some nutrients are present in the water can be indicative for malfunctioning of the reverse osmosis system. Similarly, amounts of nutrients in the water that exceed a threshold value can indicate malfunctioning of a water filtering system.

The method may further comprise said processing utility inducing addition of nutrient based on user's profile.

The method may further comprise storing the last value of P1 measured processing utility, and utilizing this value for a subsequent cycle of water dispensing and enrichment. In other words, after carrying out a cycle of dispensing that includes measuring the first value P1, determining the difference (Δ) between P1 and the desired total amount (P2) of said at least one nutrient, and enriching the water with said nutrient accordingly, the processing utility can temporarily save the measured value of P1 to be used as an initial point for calculating the required nutrient addition for a subsequent of water to be dispensed. During this subsequent cycle, the value of P1 is measured again, and is again temporarily stored to be used for the next quantity of water, and so-forth. Such temporary storage of the P1 value can shorten the time required for on-demand dispensing of water from the system/apparatus.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a block diagram of an exemplary system for mineralization (and/or addition of other additives) into drinking water according to an embodiment of this disclosure.

FIG. 1B is a block diagram of another exemplary system for mineralization (and/or addition of other additives) into drinking water that utilizes a concentrate container according to another embodiment of this disclosure.

FIG. 2 is a block diagram of a process of mineralization employed in a system of FIG. 1A.

### DETAILED DESCRIPTION OF EMBODIMENTS

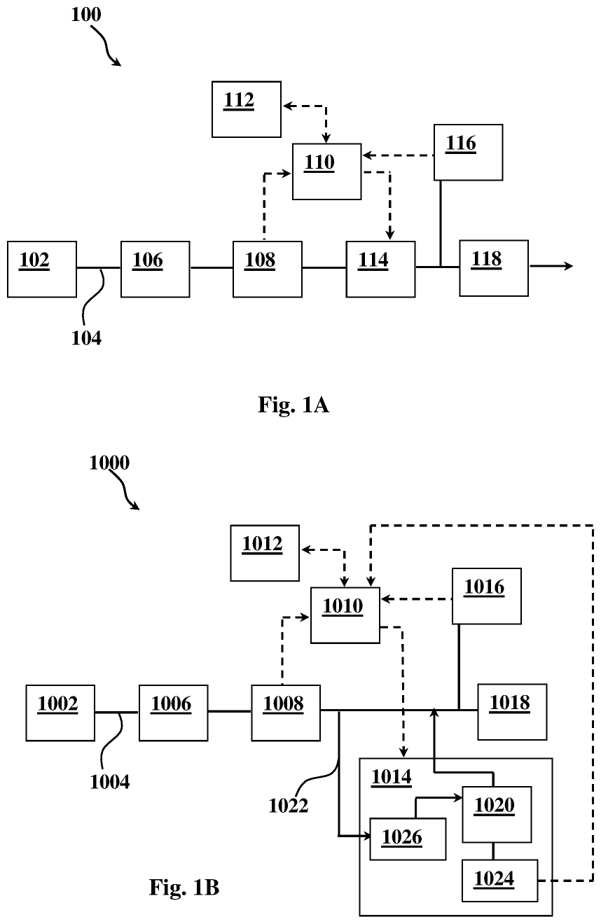

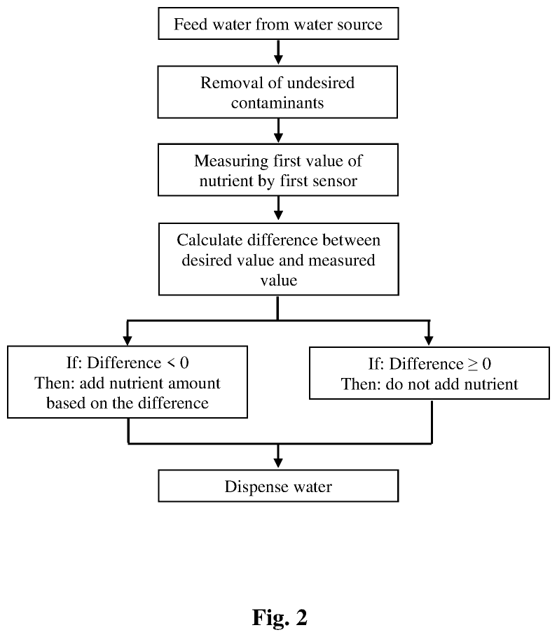

Turning to FIGS. 1A-1B and 2, shown are exemplary systems and process of operation thereof, respectively, according to embodiments of this disclosure. In the following examples, referral will be made to addition of minerals as an exemplary nutrient, it is to be understood that any other desired nutrients may be added to the water based on the principles described herein. In the system shown in FIGS. 1A-1B, solid lines represent physical connection between elements, while dashed line indicate data transfer or communication. It is to be understood that communication lines may be physical (i.e. wired) or be wireless.

System 100 comprises a water flow-line 104, extending between water source 102 and a water dispensing outlet 118. Water fed through the feed line from water source 102 are treated to remove undesired contaminants by one or more water treatment modules, collectively designated 106, for example to remove microbiological contaminants, heavy metals, organic materials, etc. It is of note, however, that module(s) 106 are designed such that no substantive removal of minerals takes place, hence maintaining substantively the content of minerals of the source water. While removal of undesired contaminants is preferable as it may assist in more accurate determination of the minerals content in the water, it is not mandatory. Hence module(s) 106 can also be absent from the system.

A first sensor (or first sensing module) 108 is located downstream to module(s) 106 along flow-line 104, and is configured to measure and provide a first value of at least one measurable parameter of the water, such as conductivity, turbidity, pH and any other parameter that may be correlative to the amount of the nutrient in the water.

The first value is typically transmitted from the first sensor 108 to control utility 110, and from there to a processing utility 112 (which can be an integral part of the system or may be external to the system, e.g. a server or a cloud). Processing utility 112 is configured to receive said first value, determine the amount of the nutrient (e.g. mineral) in the water based on the first value (P1), and determine the difference (Δ) between the pre-determined desired amount of the nutrient (P2) and the amount measured based on the first value (P1). The resulting calculation is then transmitted to the control utility 110. In case Δ<0, the control utility induces operation of at least one nutrient dispensing unit 114, positioned downstream to the first sensor 108, to add an added amount of nutrient into the water that is needed in order to obtain a final pre-determined concentration of the nutrient in the water before dispensing. In case Δ≥0, no added amount of nutrients is added to the water. Second sensor 116 is positioned between the nutrient dispensing unit 114 and the dispensing outlet, and functions to measure the amount of nutrient in the water after addition and before dispensing, and can communicate the measured value to control utility 110 as a quality control indicator. Once the desired amount of nutrient has been obtained, the enriched water can be dispensed through dispensing outlet 118 for consumption by the user.

As noted, the calculated difference (Δ) can also be used as an indicator for the quality of water received from the water source. In case the difference (Δ) is positive and larger than a pre-determined threshold value, this can indicate that the water is contaminated by undesired high levels of the nutrient. The system can provide indication of such high levels to the water supplier (e.g. the municipality), and even can be configured to shut-off water supply from the source to the system.

Another example is shown in FIG. 1B. Similar to the system of FIG. 1A, system 1000 comprises a water main flow-line 1004, extending between water source 1002 and a water dispensing outlet 1018. Water fed through the main feed line from water source 1002 are optionally treated to remove undesired contaminants by one or more water treatment modules, collectively designated 1006, for example to remove microbiological contaminants, heavy metals, organic materials, etc.

A first sensor (or first sensing module) 1008 is located downstream to module(s) 1006 along the main flow-line 1004, and is configured to measure and provide a first value of at least one measurable parameter of the water, such as conductivity, turbidity, pH and any other parameter that may be correlative to the amount of the nutrient in the water.

Nutrient dispensing unit 1014 of this example contains a concentrate receptacle 1020 that holds one or more mineral-containing solids, e.g. mineral rocks, and serves as a minerals' concentrate reservoir. The concentrate receptable 1020 is configured to receive water from the main flow line 1004 through auxiliary flow line 1022 and pass it through the mineral rock within receptacle 1020 to permit dissolution of minerals from the rocks into the water. The so-formed minerals' concentrate can then be introduced back into the main flow line 1004 to obtain water with the desired mineral profile.

In order to determine the desired volume of concentrate to be added from receptacle 1020 into the main flow line 1004, the concentration of the minerals or an indicator for the concentration of minerals (e.g. conductivity, TDS, etc.) can be measured by auxiliary sensor 1024.

Control utility 1010 then receives the first value from sensor 1008 and the mineral concentration value from auxiliary sensor 1024, and transmitted to processing utility 1012, that determine the amount of minerals in the water based on the first value (P1), and determine the difference (Δ) between the pre-determined desired amount of the minerals (P2) and the amount measured based on the first value (P1). The processing utility then determines the amount of minerals in the concentrate (P3), and based on the difference between P2 and P1, determines the volume of concentrate that needs to be added (taking into account the concentration of minerals P3 in the concentrate) in order to obtain the desired value of P2 in water to be dispensed from the main flow line. Second sensor 1016 is positioned between the nutrient dispensing unit 1014 and the dispensing outlet, and functions to measure the amount of nutrient in the water after addition and before dispensing, and can communicate the measured value to control utility 1010 as a quality control indicator. Once the desired amount of nutrient has been obtained, the enriched water can be dispensed through dispensing outlet 1018 for consumption by the user.

The nutrient dispensing unit 1014 can also comprise one or more water pre-treatment modules 1026 (e.g. a filter, a reverse osmosis unit, an ion exchanger, etc.), capable of removing at least a portion of the minerals in the auxiliary flow path 1022, for obtaining water with reduced amount of undesired minerals before enrichment with desired minerals within the concentrate receptacle.

1. A system for differential addition of at least one nutrient into drinking water, the system comprising:
a water flow-line extending between a water source and a water dispensing outlet;
at least one nutrient dispensing unit upstream the dispensing outlet configured for on-demand addition of at least one nutrient into the water flow-line;
at least one first sensor configured to provide a first value of at least one measurable parameter of the water that is correlative to the amount of said at least one nutrient in water from the water source, the at least one sensor being positioned upstream the at least one nutrient dispensing unit in the flow-line; and
a processing and controlling utility configured to receive said first value from said at least one first sensor, determine the amount of said nutrient in the water based on said first value, and determine an amount of said at least one nutrient to be added to the water from said nutrient dispensing unit for obtaining a pre-determined total amount of said nutrient in the water.

2. The system of claim 1, wherein the processing and controlling utility is configured to (i) calculate a difference between a desired total amount of said at least one nutrient in the water and the amount of said nutrient based on said first value, and (ii) operate the nutrient dispensing unit to add an added amount of said nutrient to the water, said added amount being correlative to said difference.

3. The system of claim 1, wherein said at least one parameter is selected from the group consisting of conductivity, total dissolved solids (TDS), pH, turbidity, nutrient content, color, light absorbance, and salinity.

4. The system of claim 1, wherein said at least one first sensor is selected from a conductivity sensor, an optical sensor, a spectroscopic sensor, a magnetic sensor, a laser sensor, a viscosity sensor, and a radiofrequency sensor.

5. The system of claim 1, wherein said system comprises at least one second sensor, positioned between said nutrient dispensing unit and said water dispensing outlet, configured to provide a second value of said measurable parameter.

6. The system of claim 5, wherein said at least one second sensor is selected from the group consisting of a conductivity sensor, an optical sensor, a spectroscopic sensor, a magnetic sensor, a laser sensor, a viscosity sensor, and a radiofrequency sensor.

7. The system of claim 1, wherein said system comprises at least one temperature sensor configured to measure the temperature of the water in said flow-line.

8. The system of claim 7, wherein the processing and controlling unit is configured to receive the measured temperature and determine the amount of said nutrient based on said first value as a function of said measured temperature.

9. The system of claim 1, further comprising at least one additional sensor selected from the group consisting of a pH sensor, alkalinity sensor, turbidity sensor, a total dissolved solids (TDS) sensor, and a flow sensor.

10. (canceled)

11. The system of claim 1, further comprising one or more water treatment modules, located upstream said first sensor.

12. (canceled)

13. The system of claim 1, wherein said at least one nutrient is at least one mineral selected from the group consisting of calcium, magnesium, zinc, selenium, phosphorus, potassium, sulfur, sodium, chloride, iron, copper, manganese, iodine, molybdenum, chromium, fluoride, inorganic salts thereof, and organic salts thereof.

14. (canceled)

15. The system of claim 1, further comprising at least one additive dispensing unit, positioned downstream said nutrient dispensing unit, and configured to add a desired amount of at least one additive to the water, said additive is selected from the group consisting of vitamins, amino acids, fatty acids, proteins, flavoring agents, odorants, food supplements, peptides, antioxidants, nutraceuticals, probiotics, emulsifiers, thickening agents, antifoaming, colorants, flavor masking agents, preservatives, stabilizers, stimulants (such as caffeine, tea extract or concentrate, coffee extract or concentrate, chocolate), alcoholic compounds, juices, juice concentrates and any combination thereof.

16. (canceled)

17. The system of claim 1, wherein said nutrient dispensing unit comprises at least one container for holding a composition comprising said at least one nutrient.

18. (canceled)

19. (canceled)

20. The system of claim 17, wherein said composition is a concentrate of said at least one nutrient.

21. The system of claim 17, wherein said nutrient dispensing unit comprises a plurality of containers, each independently holding a different composition, and said processing and controlling unit is configured to selectively add a required amount of nutrients from said plurality of containers as a function of said first value.

22. (canceled)

23. The system of claim 1, wherein said nutrient is at least one mineral, and said nutrient dispensing unit comprises a concentrate receptacle holding one or more mineral-containing solids, the concentrate receptable being configured to receive water from the water flow line and controllably dispense mineral concentrate into the flow-line downstream the at least one first sensor.

24. The system of claim 23, wherein the nutrient dispensing unit comprises at least one auxiliary sensor for determining the amount of minerals in the concentrate before dispensing the concentrate into the flow-line, said processing and controlling utility is configured to receive a mineral concentration value from the auxiliary sensor, and determine the volume of concentrate to be added into the flow line based on said first value and said mineral concentration value for obtaining a pre-determined total amount of minerals in the water.

25. (canceled)

26. The system of claim 23, wherein the nutrient dispensing unit further comprises at least one water pre-treatment module, disposed between the water flow line and a water inlet of the concentrate receptacle.

27. The system of claim 1, wherein said pre-determined total amount of said nutrient is based on a user's profile and said processing and controlling utility is configured to induce addition of nutrient based on said user's profile.

28. (canceled)

29. A system for differential addition of at least one nutrient into drinking water, the system comprising:
a water flow-line extending between a water source and a water dispensing outlet;
at least one nutrient dispensing unit upstream the dispensing outlet configured for on-demand addition of at least one nutrient into the water flow-line;
at least one first sensor configured to provide a first value of at least one measurable parameter of the water that is correlative to the amount of said at least one nutrient in water from the water source, the at least one sensor being positioned upstream the at least one nutrient dispensing unit in the flow-line; and
a controller configured to transmit said first value to a processing utility, receive from said processing utility a calculated value indicative of the difference between a measured amount of said nutrient based on said first value and a pre-determined total desired amount said nutrient, and operate said nutrient dispensing unit to dispense an added amount of said nutrient to the water based on said calculated value.

30. A water dispenser comprising the system of any one of claims 1 to 29.

31. The water dispenser of claim 30, further comprising a water carbonation unit for carbonating the water prior to dispensing.

32.-41. (canceled)
